(19) United States
(12) Patent Application Publication
(10) Pub. No.: US 2010/0175805 A1
(43) Pub. Date: Jul. 15, 2010

(54) RUBBER COMPOSITION FOR COVERING TEXTILE CORD AND TIRE EMPLOYING THE SAME

(76) Inventor: Takao WADA, Kobe-shi (JP)

Correspondence Address: BIRCH STEWART KOLASCH & BIRCH, PO BOX 747, FALLS CHURCH, VA, 22040-0747, US

(21) Appl. No.: 12/648,146

(22) Filed: Dec. 28, 2009

(30) Foreign Application Priority Data
Jan. 9, 2009 (JP) 2009-003934 (P)

(51) Int. Cl. B60C 9/02; C08K 5/34

(52) U.S. Cl. 152/548; 524/105

(57) ABSTRACT

A rubber composition for covering a textile cord according to the present invention contains silica and 0.5 to 4 parts by mass of a 1,3-bis(citraconimidomethyl) compound with respect to 100 parts by mass of a rubber component containing natural rubber and/or epoxidized natural rubber. Thus, a rubber composition for covering a textile cord, mainly composed of a raw material derived from non-petroleum resources, excellent in heat resistance and durability and a tire employing the same can be provided in consideration of the environment and in preparation for future depletion of petroleum resources.

This nonprovisional application is based on Japanese Patent Application No. 2009-003934 filed on Jan. 9, 2009 with the Japan Patent Office, the entire contents of which are hereby incorporated by reference.

### BACKGROUND OF THE INVENTION

1. Field of the Invention

The present invention relates to a rubber composition for covering a textile cord and a tire employing the same.

2. Description of the Background Art

In a tire for an automobile to which a large load is applied, a textile cord is generally employed as a reinforcer for a carcass ply or a belt. Particularly when rubber peels off the cord due to heat generated by the tire during traveling of the automobile, this results in a critical failure of the tire.

In general, a raw material such as carbon black derived from petroleum resources is mainly used for a rubber composition for covering a textile cord. In consideration of the increasing interest in environmental protection, however, the emission of CO₂ into the atmosphere has recently been strongly controlled without exception of automobiles. Further, the supply of the limited petroleum resources is so reduced year by year that a sudden rise in oil prices is predicted and there is a limit to the use of raw materials such as carbon black derived from petroleum resources. As to the performance of a tire, rolling resistance must be reduced in order to improve fuel efficiency in consideration of the environment, and durability (rubber strength) must be improved in order to increase the life of the tire.

Employment of silica as a raw material derived from petroleum resources in place of carbon black is known as a technique of reducing the rolling resistance. When silica is blended into the rubber composition in place of carbon black, not only the rolling resistance but also the ratio of the raw material derived from petroleum resources can be reduced in consideration of the environment and in preparation for future depletion in the supply of petroleum resources. If silica is employed, however, Mooney viscosity of the rubber composition is disadvantageously increased to deteriorate workability.

When a rubber composition containing natural rubber or silica is applied to a carcass ply or a belt of a tire, bubbles are formed in the rubber composition due to inferior heat resistance, to reduce the time up to breakage. If a rayon cord prepared from vegetable fiber is used as a textile cord, moisture easily infiltrates into the rayon cord before vulcanization of the rubber composition to increase the moisture content in the rubber composition around the cord, to result in formation of bubbles in the rubber composition during high-speed traveling and reduction of the durability.

While Japanese Patent Laying-Open No. 2003-063206 discloses an eco-friendly tire having a carcass ply topping employing prescribed non-petroleum resources for increasing the ratio of non-petroleum resources in the tire and providing excellent gripping performance, durability and comfortableness of an automobile to which the tire is applied, further improvements are required in rolling resistance, workability and rubber strength.

### SUMMARY OF THE INVENTION

An object of the present invention is to provide a rubber composition for covering a textile cord, mainly composed of a raw material derived from non-petroleum resources, excellent in heat resistance and durability in consideration of the environment and in preparation for future depletion in the supply of petroleum resources and a tire employing the same.

The present invention provides a rubber composition for covering a textile cord, containing silica and 0.5 to 4 parts by mass of a 1,3-bis(citraconimidomethyl) compound with respect to 100 parts by mass of a rubber component containing natural rubber and/or epoxidized natural rubber.

In the rubber composition for covering a textile cord according to the present invention, the content of the said silica is preferably 25 to 80 parts by mass with respect to 100 parts by mass of the said rubber component.

In the rubber composition for covering a textile cord according to the present invention, the said rubber component preferably consists of 10 to 100 mass % of epoxidized natural rubber and 0 to 90 mass % of natural rubber.

The present invention also provides a tire having a carcass ply obtained by covering a textile cord with the said rubber composition for covering a textile cord.

The present invention further provides a tire having a belt obtained by covering a textile cord with the said rubber composition for covering a textile cord.

According to the present invention, a rubber composition for covering a textile cord, mainly composed of a raw material derived from non-petroleum resources, excellent in heat resistance and durability in consideration of the environment and in preparation for future depletion in the supply of petroleum resources and a tire employing the same can be provided by mixing prescribed quantities of a prescribed rubber component, a 1,3-bis(citraconimidomethyl) compound and silica with each other.

The foregoing and other objects, features, aspects and advantages of the present invention will become more apparent from the following detailed description of the present invention.

### DESCRIPTION OF THE PREFERRED EMBODIMENTS

<Rubber Composition for Covering Textile Cord>

The rubber composition for covering a textile cord according to the present invention is prepared by mixing natural rubber and/or epoxidized natural rubber, a 1,3-bis(citraconimidomethyl) compound and silica with each other.

(Rubber Component)

As a rubber component, the rubber composition for covering a textile cord according to the present invention contains natural rubber (NR) and/or epoxidized natural rubber (ENR) in consideration of the environment and in preparation for future depletion in the supply of petroleum resources. Other rubber components are not particularly restricted, and the rubber composition for covering a textile cord according to the present invention can contain butadiene rubber (BR), styrene-butadiene rubber (SBR), isoprene rubber (IR), isobutylene-isoprene rubber (IIR), acrylonitrile-butadiene rubber (NBR), ethylene-propylene-diene rubber (EPDM), halogenated isobutylene-isoprene rubber (X-IIR) and the like. However, these rubber components are unpreferable in view of the environment, and hence only NR and/or ENR is more preferably employed as the rubber component.

NR such as RSS#3 or TSR20 generally used in the rubber industry can be employed.

Also ENR generally used in the rubber industry can be employed with no particular restriction. In particular, the epoxidation rate of ENR is preferably not more than 50 mole %. If the epoxidation rate exceeds 50 mole %, the rubber composition for covering a textile cord tends to cause violent reversion and remarkable reduction of the physical properties.

The rubber component preferably contains 10 to 100 mass % of ENR, with the rest consisting of 0 to 90 mass % of natural rubber. The polarity of the rubber component is increased due to the blending of ENR, whereby adhesion between the rubber composition for covering a textile cord according to the present invention and the textile cord can be improved. The lower limit of the content of ENR in the rubber component is preferably at least 15 mass %, more preferably at least 20 mass %. The upper limit of the content of ENR in the rubber component is more preferably not more than 70 mass %.

(1,3-Bis(Citraconimidomethyl) Compound)

In the rubber composition for covering a textile cord according to the present invention, 0.5 to 4 parts by mass of a 1,3-bis(citraconimidomethyl) compound is blended with respect to 100 parts by mass of the rubber component. While NR and/or ENR is used as the rubber component in the present invention in order to increase the ratio of non-petroleum resources, reversion of NR is caused due to heat generated in high-speed traveling, and bubbles are formed on a weakened portion of the rubber component due to expansion of a gasified component. In the rubber composition for covering a textile cord according to the present invention, further, bubbles derived from expansion of water vapor are easily formed due to silica having a high moisture content. A similar phenomenon is easily caused also when a rayon cord having a high moisture content is used as the textile cord. In the rubber composition for covering a textile cord according to the present invention, heat resistance and high-speed durability can be improved due to the 1,3-bis(citraconimidomethyl) compound contained as an antireversion agent.

The 1,3-bis(citraconimidomethyl) compound is preferably prepared from biscitraconimide having thermal stability and excellent dispersibility into rubber. More specifically, the 1,3-bis(citraconimidomethyl) compound can be prepared from 1,2-biscitraconimidomethyl benzene, 1,3-biscitraconimidomethyl benzene, 1,4-biscitraconimidomethyl benzene, 1,6-biscitraconimidomethyl benzene, 2,3-biscitraconimidomethyl toluene, 2,4-biscitraconimidomethyl toluene, 2,5-biscitraconimidomethyl toluene, 2,6-biscitraconimidomethyl toluene, 1,2-biscitraconimidoethyl benzene, 1,3-biscitraconimidoethyl benzene, 1,4-biscitraconimidoethyl benzene, 1,6-biscitraconimidoethyl benzene, 2,3-biscitraconimidoethyl toluene, 2,4-biscitraconimidoethyl toluene, 2,5-biscitraconimidoethyl toluene or 2,6-biscitraconimidoethyl toluene. In particular, 1,3-biscitraconimidomethyl benzene having thermal stability and excellent dispersibility into rubber is preferably employed.

1,3-biscitraconimidomethyl benzene is expressed in the following chemical formula:

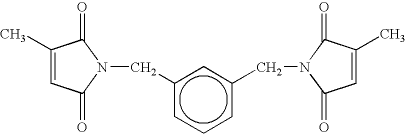

(Silica)

Silica is blended into the rubber composition for covering a textile cord according to the present invention.

Silica is not particularly restricted, but can be prepared by a wet or dry process. Dry silica having a low moisture content is preferably employed in order to prevent formation of bubbles in the rubber component following reversion.

The nitrogen adsorption specific surface area (N₂SA) of silica is at least 70 m²/g, preferably at least 80 m²/g, more preferably at least 90 m²/g. If the nitrogen adsorption specific surface area of silica is less than 70 m²/g, no sufficient effect of reinforcing the rubber composition is attained by blending silica. The nitrogen adsorption specific surface area of silica is not more than 150 m²/g, preferably not more than 130 m²/g. If the nitrogen adsorption specific surface area of silica exceeds 150 m²/g, Mooney viscosity tends to be excessively increased to reduce workability for covering the textile cord. The nitrogen adsorption specific surface area of silica can be measured according to ASTM-D-4820-93.

The content of silica is preferably at least 25 parts by mass, more preferably at least 30 parts by mass with respect to 100 parts by mass of the rubber component. If the content of silica is less than 25 parts by mass, a problem tends to arise on a rubber reinforcing surface. Further, the content of silica is preferably not more than 80 parts by mass, more preferably not more than 75 parts by mass. If the content of silica exceeds 80 parts by mass, no sufficient effect of suppressing reversion tends to be attained due to adsorption of an accelerator to the surface of silica.

(Silane Coupling Agent)

An agent generally known as a coupling agent is preferably blended into the rubber composition for covering a textile cord according to the present invention employing silica. The coupling agent can be prepared from γ-aminopropyl triethoxysilane, vinyl triethoxysilane, N-β-aminoethyl-γ-aminopropyl trimethyoxysilane, γ-chloropropyl trimethoxysilane, γ-mercaptopropyl trimethoxysilane, N-phenyl-γ-aminopropyl trimethoxysilane, γ-glycidoxypropyl trimethoxysilane or bis-(3-triethoxysilylpropyl)-tetrasulfide. The content of the coupling agent is in the range of 5 to 20 mass % of the silica content. The tire remarkably generates heat if the quantity of the coupling agent is small, while hardness of rubber is increased to reduce rubber chipping performance upon traveling on a bad road if the quantity of the coupling agent is excessive. In the latter case, the cost for the rubber composition is increased to result in inferior practicality.

(Filler)

In the rubber composition for covering a textile cord according to the present invention, carbon black, calcium carbonate, aluminum oxide or silica can be employed as a filler. The filler preferably contains at least 85 mass % of silica.

The content of the filler is preferably at least 25 parts by mass, more preferably at least 30 parts by mass with respect to 100 parts by mass of the rubber component. If the content of the filler is less than 25 parts by mass, no sufficient reinforcing effect tends to be attained. Further, the content of the filler is preferably not more than 80 parts by mass, more preferably not more than 75 parts by mass. If the content of the filler exceeds 80 parts by mass, a disadvantage on a worked surface tends to be increased due to excessive Mooney viscosity.

(Other Compounding Agents)

In addition to the aforementioned rubber component, the 1,3-bis(citraconimidomethyl) compound, silica, the silane coupling agent and the filler, compounding agents such as a softener, an antioxidant, stearic acid, zinc oxide, a vulcanizer such as sulfur and a vulcanization accelerator generally used in the rubber industry can be properly blended into the rubber composition for covering a textile cord according to the present invention if necessary.

The rubber composition for covering a textile cord according to the present invention is mainly composed of the raw material derived from non-petroleum resources, in consideration of the environment and in preparation for future depletion in the supply of petroleum resources, and hence carbon black, petroleum resin or the like is preferably not employed.

<Textile Cord>

A textile cord denotes a cord prepared by stranding a plurality of filaments made of an organic fiber material such as nylon 6, nylon 66, polyethylene terephthalate (PET), polyethylene-2,6-naphthalate (PEN), polyparaphenylene terephthalamide (PPTA), polyvinyl alcohol (PVA) or rayon. One or more of these organic fiber materials can be selected for preparing the textile cord. In particular, PET having a relatively high modulus and excellent control stability is preferable. In view of environmental protection, rayon mainly made of a raw material derived from non-petroleum resources is preferably employed.

<Method of Manufacturing Rubber Composition for Covering Textile Cord>

The rubber composition for covering a textile cord according to the present invention is manufactured by a general method. In other words, the rubber composition for covering a textile cord according to the present invention can be manufactured by kneading the aforementioned compounding agents in a Banbury mixer, a kneader or an open roll mill and thereafter vulcanizing the obtained mixture.

<Method of Manufacturing Tire>

The tire according to the present invention can be manufactured by a general method with the rubber composition for covering a textile cord according to the present invention. In other words, an unvulcanized carcass ply or an unvulcanized belt is manufactured by preparing a filmlike unvulcanized rubber sheet of not more than 1 mm in thickness from the rubber composition for covering a textile cord according to the present invention mixed with the aforementioned compounding agents at need in an unvulcanized state with a calender roll or the like while properly controlling the line speed so that the rubber composition is not overheated and molded into an unvulcanized tire on a tire molding machine along with other members of the tire by an ordinary method. The tire according to the present invention is obtained by heating and pressurizing the unvulcanized tire in a vulcanizing machine.

Thus, the tire according to the present invention can be manufactured as an eco-friendly tire in consideration of the environment and in preparation for future depletion of the petroleum resources by employing the rubber composition for covering a textile cord according to the present invention.

### Examples

While the present invention is now more specifically described with reference to Examples, the present invention is not restricted to only these.

### Examples 1 to 4 and Comparative Examples 1 to 5

[Preparation of Unvulcanized Rubber Sheet and Vulcanized Rubber Sheet]

A kneaded substance was obtained by filling chemicals other than insoluble sulfur and a vulcanization accelerator CZ to reach a fill factor of 58% with a Banbury mixer of 1.7 L by Kobe Steel, Ltd. according to blending prescriptions shown in Table 1 and kneading the same for 3 minutes at a speed of 90 rpm to reach a temperature of 150° C. Then, a thin filmlike unvulcanized rubber sheet having a thickness of 0.7 mm was obtained according to each of Examples 1 to 4 and comparative examples 1 to 5 by adding insoluble sulfur and the vulcanization accelerator CZ to the obtained kneaded substance with a calender roll and kneading the mixture for 3 minutes in conditions of a line speed of 20 rpm and a temperature of 90° C. Further, a vulcanized rubber sheet according to each of Examples 1 to 4 and comparative examples 1 to 5 was prepared by vulcanizing the obtained unvulcanized rubber sheet for 10 minutes in a temperature condition of 175° C.

(Static Heat Test)

In order to investigate heat resistance, a 5 mm-square test piece was prepared from the aforementioned vulcanized rubber sheet and left for 30 minutes in a prescribed temperature condition, to confirm whether or not bubbles were formed in the vulcanized substance. The test was conducted at a pitch of 10° C., to evaluate a bubbling temperature as a static heat test temperature (° C.).

(Peeling Test)

A peeling test sample was prepared by covering rayon cords or polyester cords arranged at regular intervals with the aforementioned unvulcanized rubber sheet and press-vulcanizing the same for 30 minutes in a temperature condition of 150° C. Then, the surface of the peeling test sample was notched in a width of 25 mm and peeled with a tensile tester by Instron Japan Co., Ltd. at a tension speed of 50 mm/min., to measure peel strength (N/25 mm) of the sample. The ratio of the peeled surface of the fiber cord covered with the rubber sheet was expressed as a rubber coverage (100%: fully covered). Adhesiveness is improved as the peel strength and the rubber coverage are increased.

[Preparation of Tire]

A test tire (size: 195/65R15) was manufactured by covering a textile cord with the aforementioned unvulcanized rubber sheet for preparing an unvulcanized carcass, bonding the carcass to other tire members and vulcanizing the same for 10 minutes in a temperature condition of 175° C. As to textile cords, polyester cords were used for tires according to Example 1 and comparative examples 1 and 2, while rayon cords were used for tires according to Examples 2 to 4 and comparative examples 3 to 5.

(High-Speed Durability Test)

Each test tire was driven on a drum in a stepped speed system of 200 km/h to 10 km/h-20 min. according to ECE30 in conditions of an internal pressure of 280 kPa and a load of 4.4 kN, to measure a traveling distance up to breakage of the tire.

(Evaluation Results)

Table 1 shows the results of evaluation in the aforementioned tests.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| Loading | Natural Rubber | 100 | 100 | 80 | 50 | 70 | 100 | 100 | 80 | 50 |
| (parts by mass) | SBR | — | — | — | — | 30 | — | — | — | — |
| | Epoxidized Natural | — | — | 20 | 50 | — | — | — | 20 | 50 |
| | Rubber | | | | | | | | | |
| | Carbon Black | — | — | — | — | 45 | — | — | — | — |
| | Silica | 50 | 50 | 50 | 50 | — | 50 | 50 | 50 | 50 |
| | Silane Coupling Agent | 4 | 4 | 4 | 4 | — | 4 | 4 | 4 | 4 |
| | Aromatic Oil | — | — | — | — | 8 | — | — | — | — |
| | 1,3-Bis(Citraconimidomethyl) | 2 | 2 | 2 | 2 | — | — | — | — | — |
| | Benzene | | | | | | | | | |
| | Stearic Acid | 2 | 2 | 2 | 2 | 2 | 2 | 2 | 2 | 2 |
| | Zinc White | 5 | 5 | 5 | 5 | 5 | 5 | 5 | 5 | 5 |
| | Insoluble Sulfur | 3 | 3 | 3 | 3 | 3 | 3 | 3 | 3 | 3 |
| | Vulcanization Accelerator | 1 | 1 | 1 | 1 | 1 | 1 | 1 | 1 | 1 |
| | Total | 167 | 167 | 167 | 167 | 164 | 165 | 165 | 165 | 165 |
| | Ratio of Non-Petroleum | 98.2 | 98.2 | 98.2 | 98.2 | 48.8 | 99.4 | 99.4 | 99.4 | 99.4 |
| | Resources | | | | | | | | | |
| Cord | Polyester Cord | YES | NO | NO | NO | YES | YES | NO | NO | NO |
| | Ratio of Non-Petroleum | 0% | — | — | — | 0% | 0% | — | — | — |
| | Resources | | | | | | | | | |
| | Rayon Cord | NO | YES | YES | YES | NO | NO | YES | YES | YES |
| | Ratio of Non-Petroleum | — | 100% | 100% | 100% | — | — | 100% | 100% | 100% |
| | Resources | | | | | | | | | |
| Evaluation | Static Heat Test (° C.) | 250 | 250 | 250 | 250 | 260 | 220 | 220 | 220 | 220 |
| | Peeling Test | | | | | | | | | |
| | Peel Strength | 23 | 21 | 25 | 25 | 25 | 22 | 20 | 24 | 25 |
| | (N/25 mm) | | | | | | | | | |
| | Rubber Coverage (%) | 80 | 70 | 80 | 90 | 90 | 80 | 70 | 80 | 90 |
| | High-Speed Durability | 250 | 230 | 240 | 250 | 250 | 220 | 210 | 210 | 210 |
| | Test (km) | | | | | | | | | |

Natural Rubber: STR20
SBR: SBR1502 by Sumitomo Chemical Co., Ltd.
Epoxidized Natural Rubber: ENR25 (epoxidation rate: 25%) by Kumpulan Guthrie Berhad
Carbon Black: Seast 3 (N₂SA: 79 m²/g) by Tokai Carbon Co., Ltd.
Silica: Ultrasil VN3 (wet silica, N₂SA: 175 m²/g) by Degussa GmbH
Silane Coupling Agent: Si69 (bis(3-triethoxysilylpropyl) tetrasulfide) by Degussa GmbH
Aromatic Oil: Process X-140 by Japan Energy Corporation
1,3-Bis(citraconimidomethyl) Benzene: Perkalink 900 by Flexys Limited
Stearic Acid: “Tsubaki” by Nippon Oil and Fats Co., Ltd.
Zinc White: Zinc White No. 1 by Mitsui Mining and Smelting Co., Ltd.
Insoluble Sulfur: “Seimi Sulfur” by Tsurumi Chemical Co., Ltd.
Vulcanization Accelerator: Nocceler CZ by Ouchi Shinko Chemical Industrial
Polyester Cord: polyester cord by Union Tire Cord Ltd.
Rayon Cord: rayon cord by Union Tire Cord Ltd.

Rubber compositions for covering textile cords according to Examples 1 and 2, each containing 100 mass % of natural rubber as a rubber component as well as 50 parts by mass of silica and 2 parts by mass of 1,3-bis(citraconimidomethyl)benzene with respect to 100 parts by mass of the rubber component, were employed for covering textile cords of polyester and rayon respectively. The rubber compositions for covering textile cords according to Examples 1 and 2 exhibited superior results of the static heat test and the high-speed durability test and at least an equivalent result of the peeling test as compared with those according to comparative examples 2 and 3 each containing a rubber component similar to that in Example 1 and silica with no 1,3-bis(citraconimidomethyl)benzene. In particular, Example 1 employing the polyester cord as the textile cord exhibited excellent results of the static heat test, the peeling test and the high-speed durability test substantially equivalent to those of comparative example 1 using SBR, i.e., synthetic rubber.

A rubber composition for covering a textile cord according to Example 3, containing 80 mass % of natural rubber and 20 mass % of epoxidized natural rubber as rubber components as well as 50 parts by mass of silica and 2 parts by mass of 1,3-bis(citraconimidomethyl)benzene with respect to 100 parts by mass of the rubber components, was employed for covering a textile cord of rayon. The rubber composition for covering a textile cord according to Example 3 exhibited superior results of the static heat test and the high-speed durability test and at least an equivalent result of the peeling test as compared with that according to comparative example 4 containing rubber components similar to those in Example 3 and silica with no 1,3-bis(citraconimidomethyl)benzene.

A rubber composition for covering a textile cord according to Example 4, containing 50 mass % of natural rubber and 50 mass % of epoxidized natural rubber as rubber components as well as 50 parts by mass of silica and 2 parts by mass of 1,3-bis(citraconimidomethyl) benzene with respect to 100 parts by mass of the rubber components, was employed for covering a textile cord of rayon. The rubber composition for covering a textile cord according to Example 4 exhibited superior results of the static heat test and the high-speed durability test and at least an equivalent result of the peeling test as compared with that according to comparative example 5 containing rubber components similar to those in Example 4 and silica with no 1,3 -bis(citraconimidomethyl)benzene.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A rubber composition for covering a textile cord, containing silica and 0.5 to 4 parts by mass of a 1,3-bis(citraconimidomethyl) compound with respect to 100 parts by mass of a rubber component containing natural rubber and/or epoxidized natural rubber.

2. The rubber composition for covering a textile cord according to claim 1, wherein
the content of said silica is 25 to 80 parts by mass with respect to 100 parts by mass of said rubber component.

3. The rubber composition for covering a textile cord according to claim 1, wherein
said rubber component consists of 10 to 100 mass % of epoxidized natural rubber and 0 to 90 mass % of natural rubber.

4. A tire having a carcass ply obtained by covering a textile cord with the rubber composition for covering a textile cord according to claim 1.

5. A tire having a belt obtained by covering a textile cord with the rubber composition for covering a textile cord according to claim 1
